(19) United States
(12) Patent Application Publication
(10) Pub. No.: US 2024/0090077 A1
(43) Pub. Date: Mar. 14, 2024

(54) DISCONTINUOUS RECEPTION METHOD AND APPARATUS

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/271,167

(22) PCT Filed: Jan. 7, 2021
(86) PCT No.: PCT/CN2021/070724

§ 371 Date: Jul. 6, 2023

(51) Int. Cl. H04W 76/28; H04W 76/27

(52) U.S. Cl. CPC H04W 76/28; H04W 76/27

(57) ABSTRACT

A discontinuous reception method includes: obtaining an absolute time cycle or a physical time cycle in direct communication discontinuous reception configuration parameters; converting the absolute time cycle or the physical time cycle into a logic time cycle, the logic time cycle being a first number of logic time units; and determining, according to the logic time cycle, a moment at which discontinuous reception enters an active state.

### CROSS REFERENCE TO RELATED APPLICATIONS

The present application is a U.S. National Stage of International Application No. PCT/CN2021/070724, filed on Jan. 7, 2021, the contents of all of which are incorporated herein by reference in their entireties for all purposes.

### BACKGROUND

At present, direct communication has the advantages of short delay, small expenditure and the like, and is widely applied to fields such as direct communication between a vehicle-mounted device and a peripheral device which is close in geographic location. In the related art, in order to guarantee that time frequency resources reserved for the next cycle are located at a time unit having suitable direct transmission time frequency resources, mapping between absolute time and logic time is required for resource reservation.

### SUMMARY

The disclosure relates to the field of communications, in particular to a discontinuous reception method and apparatus.

An example of a first aspect of the disclosure provides a discontinuous reception method which is applied to user equipment and includes: obtaining an absolute time cycle or a physical time cycle in direct communication discontinuous reception configuration parameters; converting the absolute time cycle or the physical time cycle into a logic time cycle, the logic time cycle being a first number of logic time units; and determining, according to the logic time cycle, a moment at which discontinuous reception enters an active state.

An example of a second aspect of the disclosure provides another discontinuous reception method which is applied to network side device and includes: determining direct communication discontinuous reception configuration parameters, where the direct communication discontinuous reception configuration parameters at least include an absolute time cycle or a physical time cycle; the direct communication discontinuous reception configuration parameters are used for enabling a receiving end device to convert the absolute time cycle or the physical time cycle into a logic time cycle so as to determine a moment at which discontinuous reception enters an active state according to the logic time cycle; and the logic time cycle is a first number of logic time units.

An example of a third aspect of the disclosure provides an electronic device, including: at least one processor; and a memory in communication connection with the at least one processor; where the memory stores instructions capable of being executed by the at least one processor, and the instructions are executed by the at least one processor to cause the at least one processor to be capable of executing the discontinuous reception method in the example of the first aspect of the disclosure, or executing the discontinuous reception method in the example of the second aspect of the disclosure.

An example of a fourth aspect of the disclosure provides a computer readable storage medium storing computer instructions. The computer instructions are used to cause a computer to execute the discontinuous reception method in the example of the first aspect of the disclosure, or execute the discontinuous reception method in the example of the second aspect of the disclosure.

Additional aspects and advantages of the disclosure will be partially set forth in the description which follows, and a part will become apparent from the following description, or may be learned by practice of the disclosure.

### BRIEF DESCRIPTION OF THE DRAWINGS

The above and/or additional aspects and advantages of the disclosure will become apparent and easily understandable from the following description of the examples in conjunction with the accompanying drawings, where

FIG. 1 is a schematic flow diagram of a discontinuous reception method provided by an example of the disclosure.

FIG. 2 is a schematic flow diagram of another discontinuous reception method provided by an example of the disclosure.

FIG. 3 is a schematic flow diagram of another discontinuous reception method provided by an example of the disclosure.

FIG. 4 is a schematic structural diagram of a discontinuous reception apparatus provided by an example of the disclosure.

FIG. 5 is a schematic structural diagram of another discontinuous reception apparatus provided by an example of the disclosure.

FIG. 6 is a schematic structural diagram of an electronic device provided by an example of the disclosure.

### DETAILED DESCRIPTION

The examples of the disclosure are described in detail below, and instances of the examples are shown in the accompanying drawings, where the same or similar reference numerals represent the same or similar elements or elements with the same or similar functions throughout. The examples described below with reference to the accompanying drawings are illustrative and are intended to explain the disclosure, instead of being construed as limiting the disclosure.

User equipment involved in the examples of the disclosure is specifically described as follows: the user equipment may be distributed in a whole mobile communication system, and each piece of user equipment may be static or mobile. The user equipment may also be referred to by those skilled in the art as mobile stations, user stations, mobile units, user units, wireless units, remote units, mobile devices, terminal devices, wireless devices, wireless communication devices, remote devices, mobile user stations, access user equipment, mobile user equipment, wireless user equipment, remote user equipment, handheld devices, user agents, mobile clients, clients or some other appropriate terms. The user equipment may be cellular phones, personal digital assistants (PDAs), wireless modems, wireless communication devices, handheld devices, tablets, laptops, cordless telephones, wireless local loop (WLL) stations, etc., and may communicate with base stations in mobile communication systems.

In the related art, when resource reservation is performed, it is possible that the resources are located within a time range of discontinuous reception on (DRX on) with respect to absolute time and are located within a time range of discontinuous reception off (DRX off) with respect to logic time after mapping, and in addition, logic time units and absolute time units being different will lead to the situation that resource reservation gradually moves out of the time range of discontinuous reception on.

A discontinuous reception method and apparatus, user equipment, an electronic device and a storage medium proposed by the disclosure are used for solving the problem that matching between a discontinuous reception cycle and resource reservation in direct communication in the related art is poor.

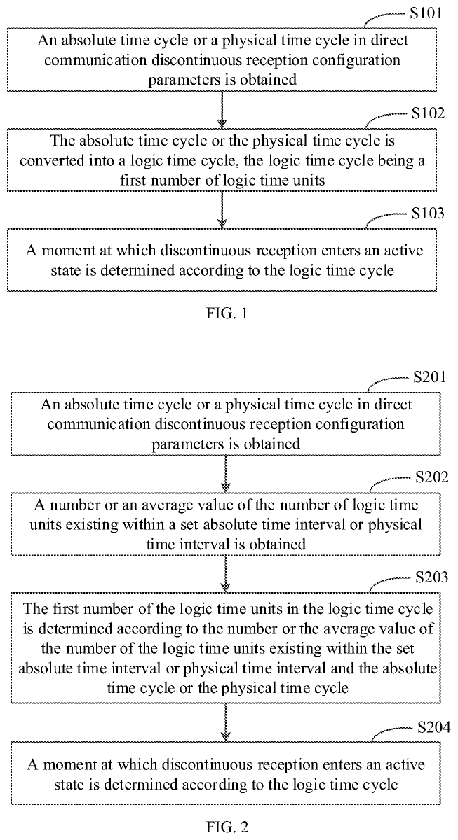

FIG. 1 is a schematic flow diagram of a discontinuous reception method provided by an example of the disclosure. The discontinuous reception method is executed by user equipment, and, as shown in FIG. 1, includes the following steps S101-S103.

In S101, an absolute time cycle or a physical time cycle in direct communication discontinuous reception configuration parameters is obtained.

In the example of the disclosure, the absolute time cycle or the physical time cycle in the direct communication discontinuous reception (DRX) configuration parameters may be obtained.

It is understandable that the absolute time cycle is one or more absolute time units, and the physical time cycle is one or more physical time units. The absolute time units include but are not limited to seconds (s), milliseconds (ms), microseconds (μs), physical frames (such as 10 ms), physical sub-frames (such as 1 ms), etc.; and one or more absolute time units may be, for example, 1 millisecond or n milliseconds, where n≥2. The physical time units include but are not limited to slots, orthogonal frequency division multiplexing (OFDM) symbols, etc.; and one or more physical time units may be, for example, 1 slot or n slots, where n≥2. In the example of the disclosure, there are not too many limitations here.

Next, in S102, the absolute time cycle or the physical time cycle is converted into a logic time cycle, the logic time cycle being a first number of logic time units.

At present, direct communication has the advantages of short delay, small expenditure and the like, and is widely applied to fields such as direct communication between a vehicle-mounted device and a peripheral device which is close in geographic location. In the related art, in order to guarantee that time frequency resources reserved for the next cycle are located at a time unit having suitable direct transmission time frequency resources, mapping between absolute time and logic time is required for resource reservation. However, when this method is used for resource reservation, it is possible that the resources are located within a time range of discontinuous reception on (DRX On) with respect to absolute time and are located within a time range of discontinuous reception off (DRX Off) with respect to logic time after mapping. In addition, logic time units and absolute time units being different will lead to the situation that resource reservation gradually moves out of the time range of discontinuous reception on.

In the example of the disclosure, the absolute time cycle or the physical time cycle may be converted into a logic time cycle, the logic time cycle being the first number of logic time units. Compared with mapping between absolute time and logic time required for resource reservation in the related art, this method may convert the absolute time cycle or the physical time cycle into the logic time cycle, and mapping between the absolute time and the logic time is not required for resource reservation, such that the matching between the discontinuous reception cycle (DRX Cycle) in the direct communication and the resource reservation is better.

In some examples, the logic time units are time units in a set obtained after absolute time units or physical time units meeting a preset condition are arranged in a time sequence. The absolute time units or physical time units meeting the preset condition may be set according to actual situations, for example, the following three possible implementations may be included.

Manner 1, the absolute time units or the physical time units meeting the preset condition may include absolute time units or physical time units configured with resources in a preset direct communication resource pool.

Manner 2, the absolute time units or the physical time units meeting the preset condition may include physical time units meeting a fact that the A^{th} to the (A+B−1)^{th} orthogonal frequency division multiplexing (OFDM) symbols are configured as uplink orthogonal frequency division multiplexing symbols.

Manner 3, the absolute time units or the physical time units meeting the preset condition may include absolute time units or physical time units meeting a fact that the A^{th} to the (A+B−1)^{th} orthogonal frequency division multiplexing symbols are configured as uplink orthogonal frequency division multiplexing symbols, not used for direct communication synchronization signal and PSBCH block (SSB) transmission and not configured as being occupied.

A and/or B are/is determined according to pre-configuration information or control information sent by a base station or a communication protocol, and the control information sent by the base station includes at least one of physical layer control information, media access control (MAC) layer control information and radio resource control (RRC) layer information.

Finally in S103, according to the logic time cycle, a moment at which discontinuous reception enters an active state is determined.

In the example of the disclosure, according to the logic time cycle, the moment at which the discontinuous reception enters the active state may be determined. It is understandable that the user equipment receives direct communication in the active state, and on the contrary, the user equipment does not receive direct communication or performs limited reception of direct communication in a non-active state.

It is understandable that the active state may be entered through starting of a discontinuous reception duration timer, that is, the user equipment may be made to enter the active state by starting the discontinuous reception duration timer. In some examples, a starting moment of the discontinuous reception duration timer may be determined according to the logic time cycle, and the starting moment of the discontinuous reception duration timer is the moment at which the discontinuous reception enters the active state.

According to the discontinuous reception method in the example of the disclosure, the absolute time cycle or the physical time cycle in the direct communication discontinuous reception configuration parameters is obtained, the absolute time cycle or the physical time cycle is converted into the logic time cycle, the logic time cycle being the first number of logic time units, and according to the logic time cycle, the moment at which the discontinuous reception enters the active state is determined. Thus, compared with mapping between absolute time and logic time required for resource reservation in the related art, the method may convert the absolute time cycle or the physical time cycle into the logic time cycle, and mapping between the absolute time and the logic time is not required for resource reservation, such that the matching between the discontinuous reception cycle in the direct communication and the resource reservation is better.

FIG. 2 is a schematic flow diagram of another discontinuous reception method provided by an example of the disclosure, and the method is executed by user equipment. As shown in FIG. 2, the discontinuous reception method includes the following steps S201-S204.

In S201, an absolute time cycle or a physical time cycle in direct communication discontinuous reception configuration parameters is obtained.

In the example of the disclosure, step S201 may be implemented by adopting any manner in the examples of the disclosure, which is not limited in the example of the disclosure and is not repeated.

Next, in S202, a number or an average value of the number of logic time units existing within a set absolute time interval or physical time interval is obtained.

In the example of the disclosure, the number or the average value of the number of the logic time units existing within the set absolute time interval or physical time interval may be obtained. The set absolute time interval or physical time interval may be set according to actual situations, and it is understandable that the number of the logic time units existing within a plurality of set absolute time intervals or physical time intervals may be obtained, and the average value of the number of the logic time units existing within the set absolute time intervals or physical time intervals may be obtained according to the number.

Then S203, the first number of the logic time units in the logic time cycle is determined according to: the number or the average value of the number of the logic time units existing within the set absolute time interval or physical time interval; and the absolute time cycle or the physical time cycle.

In some examples, determining the first number of the logic time units in the logic time cycle according to the number or the average value of the number of the logic time units existing within the set absolute time interval or physical time interval and the absolute time cycle or the physical time cycle, may be implemented through the following formula (1):

$$A = T \frac{M}{K} \qquad ( 1 )$$

In formula (1), A is the first number of the logic time units in the logic time cycle, T is the absolute time cycle or the physical time cycle, K is the set absolute time interval or physical time interval, and M is the number or the average value of the number of the logic time units existing within the set absolute time interval or physical time interval.

Finally, in S204, according to the logic time cycle, a moment at which discontinuous reception enters an active state is determined.

In the example of the disclosure, step S204 may be implemented by adopting any manner in the examples of the disclosure, which is not limited in the example of the disclosure and is not repeated.

According to the discontinuous reception method in the example of the disclosure, the absolute time cycle or the physical time cycle in the direct communication discontinuous reception configuration parameters is obtained, the number or the average value of the number of the logic time units existing within the set absolute time interval or physical time interval is obtained, the first number of the logic time units in the logic time cycle is determined according to the number or the average value of the number of the logic time units existing within the set absolute time interval or physical time interval and the absolute time cycle or the physical time cycle, and the moment at which the discontinuous reception enters the active state is determined according to the logic time cycle. Thus, the first number of the logic time units in the logic time cycle may be determined according to the number or the average value of the number of the logic time units existing within the set absolute time interval or physical time interval and the absolute time cycle or the physical time cycle, such that the absolute time cycle or the physical time cycle is converted into the logic time cycle.

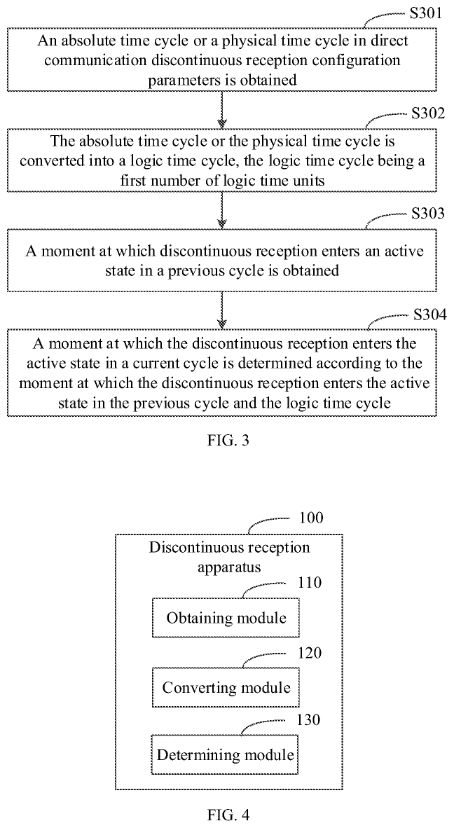

FIG. 3 is a schematic flow diagram of another discontinuous reception method provided by an example of the disclosure, and the method is executed by user equipment. As shown in FIG. 3, the discontinuous reception method includes the following steps S301-S304.

In S301, an absolute time cycle or a physical time cycle in direct communication discontinuous reception configuration parameters is obtained.

Next, in S302, the absolute time cycle or the physical time cycle is converted into a logic time cycle, the logic time cycle being a first number of logic time units.

In the example of the disclosure, step S301 and step S302 may be implemented respectively by adopting any manner in the examples of the disclosure, which is not limited in the example of the disclosure and is not repeated.

Then, in S303, a moment at which discontinuous reception enters an active state in a previous cycle is obtained.

Finally, in S304, a moment at which the discontinuous reception enters the active state in a current cycle is determined according to the moment at which the discontinuous reception enters the active state in the previous cycle and the logic time cycle.

In the example of the disclosure, the moment at which the discontinuous reception enters the active state in the previous cycle may be obtained, and the moment at which the discontinuous reception enters the active state in the current cycle may be determined according to the moment at which the discontinuous reception enters the active state in the previous cycle and the logic time cycle.

In some examples, determining the moment at which the discontinuous reception enters the active state in the current cycle according to the moment at which the discontinuous reception enters the active state in the previous cycle and the logic time cycle, may include a time interval between the moment at which the discontinuous reception enters the active state in the current cycle and the moment at which the discontinuous reception enters the active state in the previous cycle is the logic time cycle.

For example, if the moment at which the discontinuous reception enters the active state in the previous cycle is a slot m, the logic time cycle is k logic time units, and the moment at which the discontinuous reception enters the active state in the current cycle is a slot n, a time interval between the slot n and the slot m is the logic time cycle, that is, the time interval between the slot n and the slot m is the k logic time units.

According to the discontinuous reception method in the example of the disclosure, the absolute time cycle or the physical time cycle in the direct communication discontinuous reception configuration parameters is obtained, the absolute time cycle or the physical time cycle is converted into the logic time cycle, the logic time cycle being the first number of logic time units, the moment at which the discontinuous reception enters the active state in the previous cycle is obtained. According to the moment at which the discontinuous reception enters the active state in the previous cycle and the logic time cycle, the moment at which the discontinuous reception enters the active state in the current cycle is determined. Thus, the moment at which the discontinuous reception enters the active state in the current cycle may be determined according to the moment at which the discontinuous reception enters the active state in the previous cycle and the logic time cycle.

Based on the same idea, the disclosure further provides a discontinuous reception method, which is applied to a network side device and includes: determining direct communication discontinuous reception configuration parameters, where the direct communication discontinuous reception configuration parameters at least include an absolute time cycle or a physical time cycle; the direct communication discontinuous reception configuration parameters are used for enabling a receiving end device to convert the absolute time cycle or the physical time cycle into a logic time cycle so as to determine a moment at which discontinuous reception enters an active state according to the logic time cycle; and the logic time cycle is a first number of logic time units.

Specifically, some details in the above solution may correspond to technical details of the user equipment in any above example, and are not repeated here.

In some examples, the logic time units are time units in a set obtained after absolute time units or physical time units meeting a preset condition are arranged in a time sequence.

In some examples, converting the absolute time cycle or the physical time cycle into the logic time cycle includes: obtaining a number or an average value of the number of logic time units existing within a set absolute time interval or physical time interval; and determining the first number of the logic time units in the logic time cycle. Determining the first number of the logic time units in the logic time cycle is done according to: the number or the average value of the number of the logic time units existing within the set absolute time interval or physical time interval; and the absolute time cycle or the physical time cycle.

In some examples, determining, according to the logic time cycle, the moment at which the discontinuous reception enters the active state includes: obtaining a moment at which the discontinuous reception enters the active state in a previous cycle; and determining a moment at which the discontinuous reception enters the active state in a current cycle according to the moment at which the discontinuous reception enters the active state in the previous cycle and the logic time cycle.

In some examples, the absolute time units or the physical time units meeting the preset condition include: absolute time units or physical time units configured with resources in a preset direct communication resource pool.

In some examples, the absolute time units or the physical time units meeting the preset condition include: absolute time units or physical time units meeting a fact that the A^{th} to the (A+B−1)^{th} orthogonal frequency division multiplexing symbols are configured as uplink orthogonal frequency division multiplexing symbols. The parameter A and the parameter B are determined by the receiving end device according to control information sent by the network side device.

In some examples, the absolute time units or the physical time units meeting the preset condition include: absolute time units or physical time units meeting a fact that the A^{th} to the (A+B−1)^{th} orthogonal frequency division multiplexing symbols are configured as uplink orthogonal frequency division multiplexing symbols, not used for direct communication synchronization signal and PSBCH block transmission and not configured as being occupied. The parameter A and the parameter B are determined by the receiving end device according to control information sent by the network side device.

In some possible implementations, the control information sent by the network side device includes at least one of the following information: physical layer control information, media access control layer control information and radio resource control layer information.

Corresponding to the discontinuous reception method provided by the several examples above, the disclosure further provides a discontinuous reception apparatus. The discontinuous reception apparatus is applied to user equipment. Since the discontinuous reception apparatus provided by the example of the disclosure corresponds to the discontinuous reception method provided by the examples in FIG. 1 to FIG. 3 above, implementations of the discontinuous reception method also adapt to the discontinuous reception apparatus provided by this example, which is not described in detail in this example. FIG. 4 is a schematic structural diagram of a discontinuous reception apparatus provided according to the disclosure.

FIG. 4 is a schematic structural diagram of a discontinuous reception apparatus provided by an example of the disclosure. As shown in FIG. 4, the discontinuous reception apparatus 100 includes: an obtaining module 110, a converting module 120 and a determining module 130.

The obtaining module 110 is configured to obtain an absolute time cycle or a physical time cycle in direct communication discontinuous reception configuration parameters.

The converting module 120 is configured to convert the absolute time cycle or the physical time cycle into a logic time cycle, the logic time cycle being a first number of logic time units.

The determining module 130 is configured to determine, according to the logic time cycle, a moment at which discontinuous reception enters an active state.

In an example of the disclosure, the discontinuous reception apparatus 100 further includes a starting module, configured to enter the active state through starting of a discontinuous reception duration timer.

In an example of the disclosure, the converting module 120 includes: a first obtaining unit, configured to obtain a number or an average value of the number of the logic time units existing within a set absolute time interval or physical time interval; and a first determining unit, configured to determine the first number of the logic time units in the logic time cycle according to the number or the average value of the number of the logic time units existing within the set absolute time interval or physical time interval and the absolute time cycle or the physical time cycle.

In an example of the disclosure, the determining module 130 includes: a second obtaining unit, configured to obtain a moment at which the discontinuous reception enters the active state in a previous cycle; and a second determining unit, configured to determine a moment at which the discontinuous reception enters the active state in a current cycle according to the moment at which the discontinuous reception enters the active state in the previous cycle and the logic time cycle.

In an example of the disclosure, the logic time units are time units in a set obtained after absolute time units or physical time units meeting a preset condition are arranged in a time sequence.

In an example of the disclosure, the absolute time units or physical time units meeting the preset condition include absolute time units or physical time units configured with resources in a preset direct communication resource pool.

In an example of the disclosure, the absolute time units or physical time units meeting the preset condition include: absolute time units or physical time units meeting a fact that the A^{th} to the (A+B−1)^{th} orthogonal frequency division multiplexing symbols are configured as uplink orthogonal frequency division multiplexing symbols.

In an example of the disclosure, the absolute time units or physical time units meeting the preset condition include: absolute time units or physical time units meeting a fact that the A t to the (A+B−1)^{th} orthogonal frequency division multiplexing symbols are configured as uplink orthogonal frequency division multiplexing symbols, not used for direct communication synchronization signal and PSBCH block transmission and not configured as being occupied.

In an example of the disclosure, A and/or B are/is determined according to pre-configuration information or control information sent by a network side device.

In an example of the disclosure, the control information sent by the network side device includes at least one of the following information: physical layer control information, media access control layer control information and radio resource control layer information.

According to the discontinuous reception apparatus in the example of the disclosure, the absolute time cycle or the physical time cycle in the direct communication discontinuous reception configuration parameters is obtained, the absolute time cycle or the physical time cycle is converted into the logic time cycle, the logic time cycle being the first number of logic time units, and according to the logic time cycle, the moment at which the discontinuous reception enters the active state is determined. Thus, compared with mapping between absolute time and logic time required for resource reservation in the related art, the absolute time cycle or the physical time cycle may be converted into the logic time cycle, and mapping between the absolute time and the logic time is not required for resource reservation, such that the matching between the discontinuous reception cycle in the direct communication and the resource reservation is better.

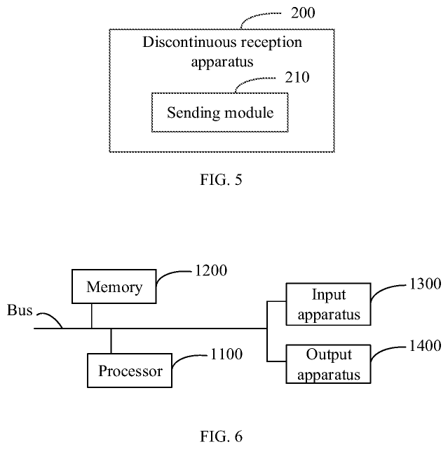

Corresponding to the discontinuous reception method provided by the several examples above, the disclosure further provides a discontinuous reception apparatus. The discontinuous reception apparatus is applied to a network side device. Since the discontinuous reception apparatus provided by the example of the disclosure corresponds to the discontinuous reception method provided by the examples of the network side device above, implementations of the discontinuous reception method also adapt to the discontinuous reception apparatus provided by this example, which is not described in detail in this example. FIG. 5 is a schematic structural diagram of a discontinuous reception apparatus provided according to the disclosure.

FIG. 5 is a schematic structural diagram of a discontinuous reception apparatus provided by an example of the disclosure. As shown in FIG. 5, the discontinuous reception apparatus 200 includes: a sending module 210.

The sending module 210 is configured to determine direct communication discontinuous reception configuration parameters. Where the direct communication discontinuous reception configuration parameters at least include an absolute time cycle or a physical time cycle; the direct communication discontinuous reception configuration parameters are used for enabling a receiving end device to convert the absolute time cycle or the physical time cycle into a logic time cycle so as to determine a moment at which discontinuous reception enters an active state according to the logic time cycle; and the logic time cycle is a first number of logic time units.

In an example of the disclosure, the logic time units are time units in a set obtained after absolute time units or physical time units meeting a preset condition are arranged in a time sequence.

In an example of the disclosure, the absolute time units or physical time units meeting the preset condition include absolute time units or physical time units configured with resources in a preset direct communication resource pool.

In an example of the disclosure, the absolute time units or physical time units meeting the preset condition include: absolute time units or physical time units meeting a fact that the A^{th} to the (A+B−1)^{th} orthogonal frequency division multiplexing symbols are configured as uplink orthogonal frequency division multiplexing symbols; or absolute time units or physical time units meeting a fact that the A^{th} to the (A+B−1)^{th} orthogonal frequency division multiplexing symbols are configured as uplink orthogonal frequency division multiplexing symbols, not used for direct communication synchronization signal and PSBCH block transmission and not configured as being occupied. Where the parameter A and the parameter B are determined by the receiving end device according to control information sent by the network side device.

In an example of the disclosure, the control information sent by the network side device includes at least one of the following information: physical layer control information, media access control layer control information and radio resource control layer information.

According to the discontinuous reception apparatus in the example of the disclosure, the direct communication discontinuous reception configuration parameters are determined, where the direct communication discontinuous reception configuration parameters at least include the absolute time cycle or the physical time cycle; the direct communication discontinuous reception configuration parameters are used for enabling the receiving end device to convert the absolute time cycle or the physical time cycle into the logic time cycle so as to determine the moment at which the discontinuous reception enters the active state according to the logic time cycle; and the logic time cycle is the first number of logic time units. Thus, the network side device may determine the absolute time cycle or the physical time cycle, so that the receiving end device may convert the absolute time cycle or the physical time cycle into the logic time cycle, and mapping between the absolute time and the logic time is not required for resource reservation, such that the matching between the discontinuous reception cycle in the direct communication and the resource reservation is better.

According to an example of the disclosure, the disclosure further provides user equipment, including the discontinuous reception apparatus 100 provided by the example of the disclosure.

According to the user equipment in the example of the disclosure, an absolute time cycle or a physical time cycle in direct communication discontinuous reception configuration parameters is obtained, the absolute time cycle or the physical time cycle is converted into a logic time cycle, the logic time cycle being a first number of logic time units, and according to the logic time cycle, a moment at which discontinuous reception enters an active state is determined. Thus, compared with mapping between absolute time and logic time required for resource reservation in the related art, the absolute time cycle or the physical time cycle may be converted into the logic time cycle, and mapping between the absolute time and the logic time is not required for resource reservation, such that the matching between the discontinuous reception cycle in the direct communication and the resource reservation is better.

According to an example of the disclosure, the disclosure further provides a network side device, including the discontinuous reception apparatus 200 provided by the example of the disclosure.

According to the network side device in the example of the disclosure, direct communication discontinuous reception configuration parameters are determined, where the direct communication discontinuous reception configuration parameters at least include an absolute time cycle or a physical time cycle; the direct communication discontinuous reception configuration parameters are used for enabling a receiving end device to convert the absolute time cycle or the physical time cycle into a logic time cycle so as to determine a moment at which discontinuous reception enters an active state according to the logic time cycle; and the logic time cycle is a first number of logic time units. Thus, the network side device may determine the absolute time cycle or the physical time cycle, so that the receiving end device may convert the absolute time cycle or the physical time cycle into the logic time cycle, and mapping between the absolute time and the logic time is not required for resource reservation, such that the matching between the discontinuous reception cycle in the direct communication and the resource reservation is better.

According to an example of the disclosure, the disclosure further provides an electronic device and a readable storage medium.

As shown in FIG. 6, it is a block diagram of an electronic device provided by an example of the disclosure. The electronic device is intended to represent various forms of digital computers, such as, a laptop computer, a desktop computer, a workstation, a personal digital assistant, a server, a blade server, a mainframe computer, and other suitable computers. The electronic device may further represent various forms of mobile apparatuses, such as, a personal digital assistant, a cell phone, a smart phone, a wearable device and other similar computing apparatuses. The components shown here, their connections and relationships, and their functions are merely used as examples, and are not intended to limit the implementations of the disclosure described and/or required here.

As shown in FIG. 6, the electronic device includes: one or more processors 1100, a memory 1200 and interfaces for being connected with various components, including a high-speed interface and a low-speed interface. The components are connected with each other by using different buses and may be installed on a common mainboard or otherwise installed as needed. The processor may process instructions executed in the electronic device, including instructions stored in the memory or on the memory to be used for displaying graphic information of a GUI on an external input/output apparatus (such as a display device coupled to the interface). In other implementations, if desired, a plurality of processors and/or a plurality of buses may be used together with a plurality of memories. Also, a plurality of electronic devices may be connected, each providing a part of necessary operations (for example, as a server array, a group of blade servers or a multi-processor system). One processor 1100 is taken as an example in FIG. 6.

The memory 1200 is a non-transitory computer readable storage medium provided by the disclosure. The memory stores instructions capable of being executed by the at least one processor, such that the at least one processor executes the discontinuous reception method provided by the disclosure. The non-transitory computer readable storage medium of the disclosure stores computer instructions, and the computer instructions are used to cause a computer to execute the discontinuous reception method provided by the disclosure.

As the non-transitory computer readable storage medium, the memory 1200 may be configured to store non-transitory software programs, and non-transitory computer-executable programs and modules, such as program instructions/modules (for example, the obtaining module 110, the converting module 120 and the determining module 130 shown in FIG. 4) corresponding to the discontinuous reception method in the examples of the disclosure. By running the non-transitory software programs, instructions and modules stored in the memory 1200, the processor 1100 executes various functional applications and data processing of servers, that is, the discontinuous reception method in the above method examples is implemented.

The memory 1200 may include a program storage area and a data storage area, where the program storage area may store an operating system and an application required for at least one function; and the data storage area may store data created according to use of a locating electronic device. In addition, the memory 1200 may include a high-speed random access memory, and may also include a non-transitory memory, such as at least one disk storage device, a flash memory device, or other non-transitory solid-state storage devices. In some examples, the memory 1200 includes a memory which is remotely disposed relative to the processor 1100, and the remote memory may be connected to the locating electronic device through a network. Instances of the above network include but are not limited to the Internet, the Intranet, the local area network, the mobile communication network and their combination.

The electronic device may further include: an input apparatus 1300 and an output apparatus 1400. The processor 1100, the memory 1200, the input apparatus 1300 and the output apparatus 1400 may be connected through a bus or other means, and bus connection is taken as an example in FIG. 6.

The input apparatus 1300 may receive input digital or character information and generate a key signal input related to user settings and function control of the locating electronic device, such as a touch screen, a keypad, a mouse, a trackpad, a touch pad, an indicator bar, one or more mouse buttons, a trackball, a joystick and other input apparatuses. The output apparatus 1400 may include a display device, an auxiliary lighting apparatus (e.g., an LED), a tactile feedback apparatus (e.g., a vibration motor), etc. The display device may include but not limited to a liquid crystal display (LCD), a light emitting diode (LED) display and a plasma display. In some implementations, the display device may be a touch screen.

Various implementations of the systems and technologies described here may be implemented in a digital electronic circuit system, an integrated circuit system, an application specific integrated circuit (ASIC), computer hardware, firmware, software and/or their combinations. These various implementations may include: being implemented in one or more computer programs, where the one or more computer programs may be executed and/or interpreted on a programmable system including at least one programmable processor, and the programmable processor may be a dedicated or general-purpose programmable processor, and may receive data and instructions from a storage system, at least one input apparatus, and at least one output apparatus, and transmit the data and the instructions to the storage system, the at least one input apparatus, and the at least one output apparatus.

These computing programs (also called programs, software, software applications, or codes) include machine instructions of programmable processors, and may be implemented using high-level procedures and/or object-oriented programming languages, and/or assembly/machine languages. As used here, the terms “machine readable medium” and “computer readable medium” refer to any computer program product, device, and/or apparatus (such as a disk, an optical disk, a memory, a programmable logic device (PLD)) used to provide machine instructions and/or data to a programmable processor, including a machine readable medium that receives machine instructions as machine readable signals. The term “machine readable signal” refers to any signal for providing the machine instructions and/or data to the programmable processor.

In order to provide interactions with users, the systems and techniques described here may be implemented on a computer, and the computer has: a display apparatus for displaying information to the users (e.g., a cathode ray tube (CRT) or a liquid crystal display (LCD) monitor); and a keyboard and a pointing apparatus (e.g., a mouse or trackball), through which the users may provide an input to the computer. Other types of apparatuses may further be used to provide interactions with the users; for example, feedback provided to the users may be any form of sensory feedback (e.g., visual feedback, auditory feedback, or tactile feedback); an input from the users may be received in any form (including an acoustic input, a voice input or a tactile input).

The systems and techniques described here may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described here), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally far away from each other and usually interact through a communication network. The relationship between the client and the server is generated by computer programs running on the corresponding computer and having a client-server relationship with each other.

According to the discontinuous reception method in the example of the disclosure, the absolute time cycle or the physical time cycle in the direct communication discontinuous reception configuration parameters is obtained, the absolute time cycle or the physical time cycle is converted into the logic time cycle, the logic time cycle being the first number of logic time units, and according to the logic time cycle, the moment at which the discontinuous reception enters the active state is determined. Thus, compared with mapping between absolute time and logic time required for resource reservation in the related art, the method may convert the absolute time cycle or the physical time cycle into the logic time cycle, and mapping between the absolute time and the logic time is not required for resource reservation, such that the matching between the discontinuous reception cycle in the direct communication and the resource reservation is better.

It is to be understood that the various forms of processes shown above may be used to reorder, add, or delete steps. For example, the steps recorded in the disclosure may be performed in parallel, sequentially or in different orders, as long as the desired results of the technical solution disclosed by the disclosure can be achieved, which is not limited here.

1. A discontinuous reception method, performed by user equipment, comprising:
obtaining an absolute time cycle or a physical time cycle in direct communication discontinuous reception configuration parameters;
converting the absolute time cycle or the physical time cycle into a logic time cycle, the logic time cycle being a first number of logic time units; and
determining, according to the logic time cycle, a moment at which discontinuous reception enters an active state.

2. The method according to claim 1, further comprising:
entering the active state through starting of a discontinuous reception duration timer.

3. The method according to claim 1, wherein converting the absolute time cycle or the physical time cycle into the logic time cycle comprises:
obtaining a number or an average value of the number of logic time units existing within a set absolute time interval or physical time interval; and
determining the first number of the logic time units in the logic time cycle according to:
the number or the average value of the number of the logic time units existing within the set absolute time interval or physical time interval; and
the absolute time cycle or the physical time cycle.

4. The method according to claim 1, wherein determining, according to the logic time cycle, the moment at which the discontinuous reception enters the active state comprises:
obtaining a moment at which the discontinuous reception enters the active state in a previous cycle; and
determining a moment at which the discontinuous reception enters the active state in a current cycle according to the moment at which the discontinuous reception enters the active state in the previous cycle and the logic time cycle.

5. The method according to claim 1, wherein the logic time units are time units in a set obtained after absolute time units or physical time units meeting a preset condition are arranged in a time sequence.

6. The method according to claim 5, wherein the absolute time units or the physical time units meeting the preset condition comprise:
absolute time units or physical time units configured with resources in a preset direct communication resource pool.

7. The method according to claim 5, wherein the absolute time units or the physical time units meeting the preset condition comprise:
absolute time units or physical time units meeting a fact that the A^{th} to the (A+B−1)^{th} orthogonal frequency division multiplexing symbols are configured as uplink orthogonal frequency division multiplexing symbols.

8. The method according to claim 5, wherein the absolute time units or the physical time units meeting the preset condition comprise:
absolute time units or physical time units meeting a fact that the A^{th} to the (A+B−1)^{th} orthogonal frequency division multiplexing symbols are configured as uplink orthogonal frequency division multiplexing symbols, not used for direct communication synchronization signal and PSBCH block transmission and not configured as being occupied.

9. The method according to claim 7, wherein A and/or B are/is determined according to pre-configuration information or control information sent by a network side device.

10. The method according to claim 9, wherein the control information sent by the network side device comprises at least one of following information:
physical layer control information, media access control layer control information and radio resource control layer information.

11. A discontinuous reception method, performed by a network side device, comprising:
determining direct communication discontinuous reception configuration parameters, wherein the direct communication discontinuous reception configuration parameters at least comprise an absolute time cycle or a physical time cycle; the direct communication discontinuous reception configuration parameters are used for enabling a receiving end device to convert the absolute time cycle or the physical time cycle into a logic time cycle so as to determine a moment at which discontinuous reception enters an active state according to the logic time cycle; and the logic time cycle is a first number of logic time units.

12. The method according to claim 11, wherein the logic time units are time units in a set obtained after absolute time units or physical time units meeting a preset condition are arranged in a time sequence.

13. The method according to claim 12, wherein the absolute time units or the physical time units meeting the preset condition comprise:
absolute time units or physical time units configured with resources in a preset direct communication resource pool.

14. The method according to claim 12, wherein the absolute time units or the physical time units meeting the preset condition comprise:
absolute time units or physical time units meeting a fact that the A^{th} to the (A+B−1)^{th} orthogonal frequency division multiplexing symbols are configured as uplink orthogonal frequency division multiplexing symbols;
wherein
the parameter A and the parameter B are determined by the receiving end device according to control information sent by the network side device.

15. The method according to claim 14, wherein the control information sent by the network side device comprises at least one of following information:
physical layer control information, media access control layer control information and radio resource control layer information.

16-17. (canceled)

18. An electronic device, comprising:
at least one processor; and
a memory in communication connection with the at least one processor; wherein
the memory stores instructions capable of being executed by the at least one processor, and the instructions are executed by the at least one processor to cause the at least one processor to be capable of executing:
obtaining an absolute time cycle or a physical time cycle in direct communication discontinuous reception configuration parameters;
converting the absolute time cycle or the physical time cycle into a logic time cycle, the logic time cycle being a first number of logic time units; and
determining, according to the logic time cycle, a moment at which discontinuous reception enters an active state.

19. A computer readable storage medium storing computer instructions, wherein the computer instructions are used to cause a computer to execute the discontinuous reception method according to claim 1.

20. The method according to claim 12, wherein the absolute time units or the physical time units meeting the preset condition comprise:
absolute time units or physical time units meeting a fact that the A^{th} to the (A+B−1)^{th} orthogonal frequency division multiplexing symbols are configured as uplink orthogonal frequency division multiplexing symbols, not used for direct communication synchronization signal and PSBCH block transmission and not configured as being occupied.

21. An electronic device, comprising:
at least one processor; and
a memory in communication connection with the at least one processor; wherein
the memory stores instructions capable of being executed by the at least one processor, and the instructions are executed by the at least one processor to cause the at least one processor to be capable of executing the discontinuous reception method according to claim 11.

22. A computer readable storage medium storing computer instructions, wherein the computer instructions are used to cause a computer to execute the discontinuous reception method according to claim 11.
